(19) United States
(12) Patent Application Publication
(10) Pub. No.: US 2009/0215374 A1
(43) Pub. Date: Aug. 27, 2009

(54) Device for the storage and dispensing of coins

(75) Inventor: Franz Wingerter, Bad Bergzabern (DE)

Correspondence Address: FAY KAPLUN & MARCIN, LLP, 150 BROADWAY, SUITE 702, NEW YORK, NY, 10038, US

(73) Assignee: Walter Hanke Mechanische Werkstatten GmbH & Co. KG

(21) Appl. No.: 11/911,368

(22) PCT Filed: Apr. 11, 2006
(86) PCT No.: PCT/EP06/03536

§ 371 Date: May 30, 2008

(30) Foreign Application Priority Data
Apr. 12, 2005 (DE) 10 2005 017 749.2

(51) Int. Cl. G07D 1/00; G07D 9/00

(52) U.S. Cl. 453/57; 453/63; 453/18

(57) ABSTRACT

A device for intermediate storage, collection and dispensing of coins contains at least one magazine for controlled reception, intermediate storage and controlled return of the coins and also an overflow for dispensing coins when the magazine is filled into a collection container. Furthermore, an additional storage space is provided for controlled reception of coins inserted during an insertion process, alternatively to reception in the magazine, and for controlled dispensing of the received coins of the one insertion process either to a return device or into the collection container. Preferably the coins are conducted, during disturbance-free operation, into the magazine and, upon a disruption in the magazine, into the storage space.

### PRIORITY CLAIM

This application claims the benefit of German Patent Application Serial No. DE 10 2005 017 749.2 filed on Apr. 12, 2005 and to PCT Patent Application Serial No. PCT/EP2006/003536 filed on Apr. 11, 2006. The specifications of these applications are expressly incorporated by reference into this application in their entirety.

The invention relates to a device according to the preamble of claim 1.

Automatic machines which accept coins contain an intermediate store in order to be able to give change. This intermediate store is also necessary in order to give back coins again when a payment process is cancelled, said coins corresponding at least in amount to the already inserted coins. The possibility thereby exists of giving back the same coins which were inserted during the interrupted payment process, or other coins which correspond only in amount to the inserted coins. The return of the same has the advantage that manipulations with invalid coins can be prevented. Intermediate stores which give back the same coins are normally drum- or disc-shaped and are rotated in opposite directions for receiving and dispensing coins, such as is shown for example in DE 43 21 859 C2. Intermediate stores which give back different coins, which correspond merely in amount, have tubes or hoppers for receiving the coins. In the case of tubes, the coins are inserted at the top and given back at the bottom; in the case of hoppers, the coins are received without order and are given back without choice.

In the case of intermediate stores of this type with return of change, the danger exists however that the result can be jamming or other disruptions to the proper operational course, in particular due to insertion of damaged or invalid coins. The normal reaction of known intermediate stores resides in the whole device being switched off so that it is no longer possible to accept coins.

It is therefore the object of the present invention to produce a device for intermediate storage, collection and dispensing of coins, having at least one magazine for controlled reception, intermediate storage and controlled return of the coins and also an overflow for dispensing coins when the magazine is filled in a collection container which is able, even when the intermediate storage fails, to maintain the function of coin acceptance and coin return when a payment process is interrupted.

This object is achieved according to the invention by a device having the features indicated in claim 1. Advantageous developments of the device according to the invention are revealed in the sub-claims.

As a result of the fact that an additional storage space is provided for controlled reception of coins inserted during an insertion process, alternatively to reception in the magazine, and for controlled dispensing of the received coins of the one insertion process either to a return device or in the collection container, the operation of the device, restricted by switching off the intermediate store, can be maintained in such a manner that the acceptance of coins and, associated therewith, provision of a return service and if necessary also the interruption of an acceptance process can be implemented by returning the already inserted coins, but the return of change is not possible.

The invention is explained in more detail subsequently with reference to embodiments represented in the Figures. There are shown:

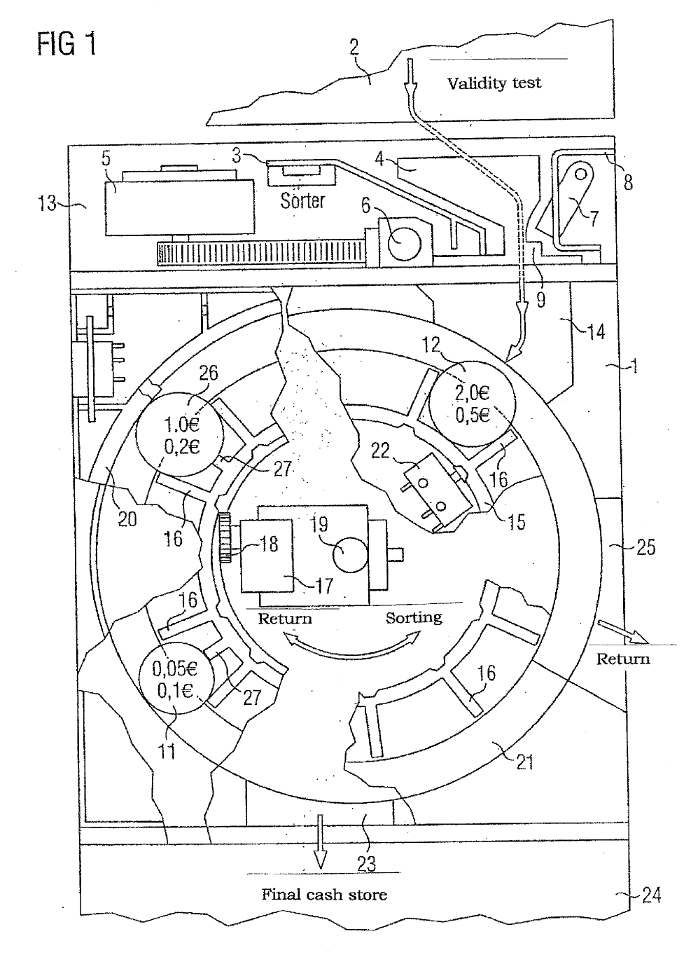

FIG. 1 a sectional view through a device with drum-shaped magazine for the intermediate storage of coins,

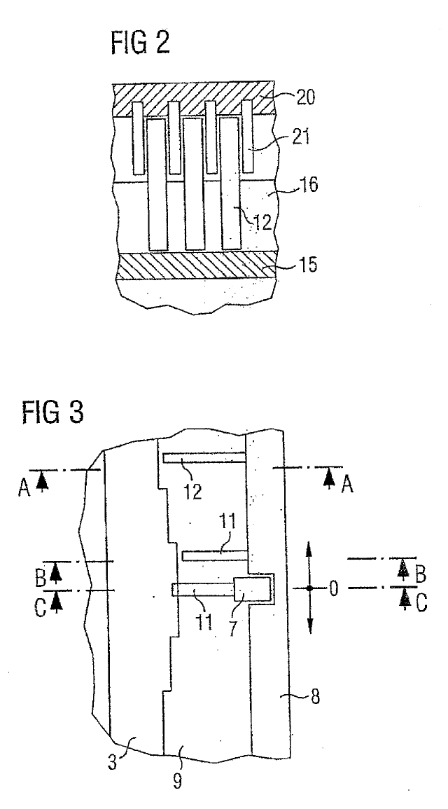

FIG. 2 a section through a part of a magazine perpendicular to the direction of rotation of the magazine,

FIG. 3 a device for sorting coins according to size in plan view,

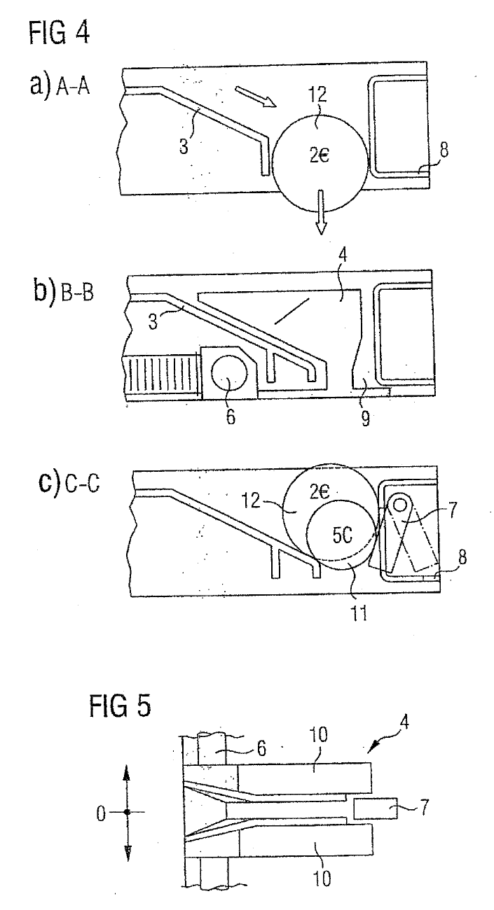

FIG. 4 the device according to FIG. 3 in several sectional views,

FIG. 5 a coin-conveying carriage in plan view,

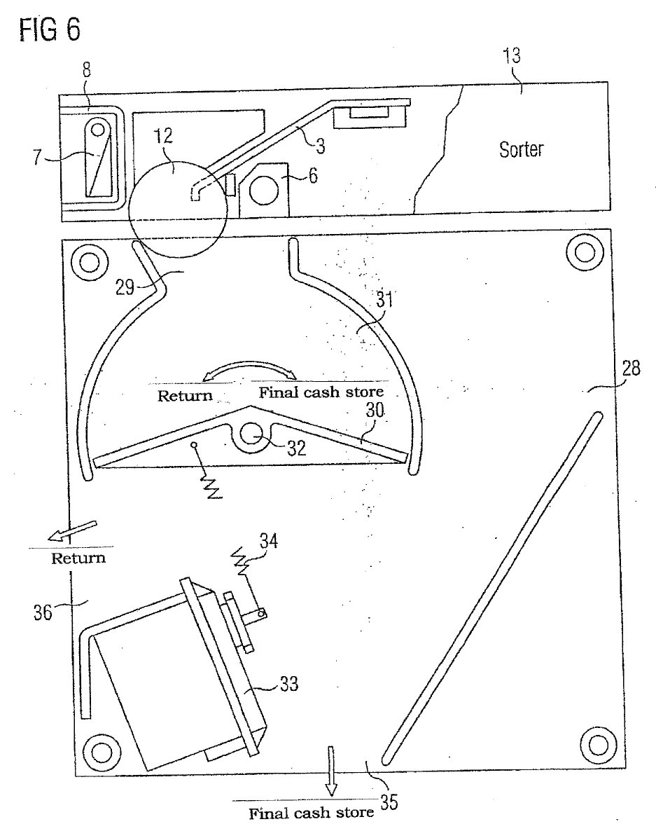

FIG. 6 a sectional view of the additional storage space without filling function of the intermediate store,

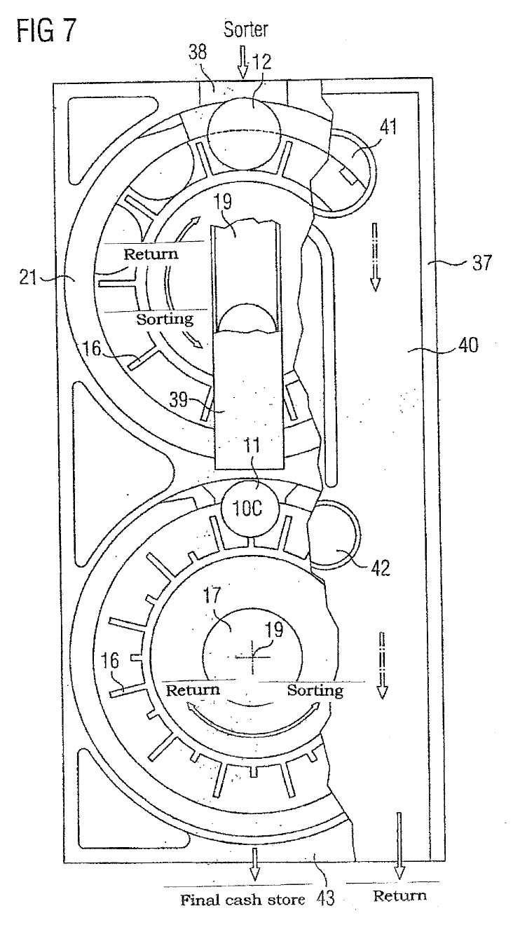

FIG. 7 a sectional view of two vane wheels of a magazine, which are disposed one above the other, with filling function,

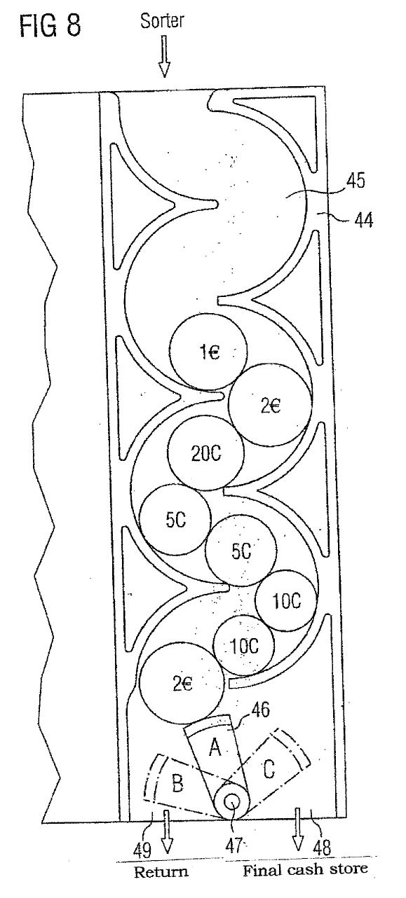

FIG. 8 a sectional view of the additional storage space without filling function of the intermediate store when using vane wheels of a magazine, which are disposed one above the other, with filling function,

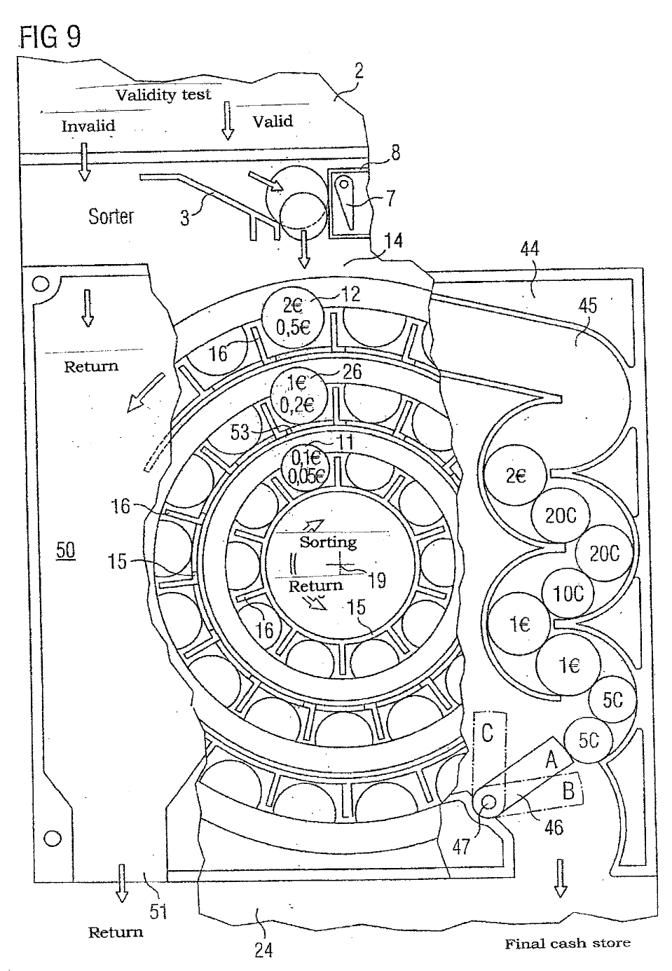

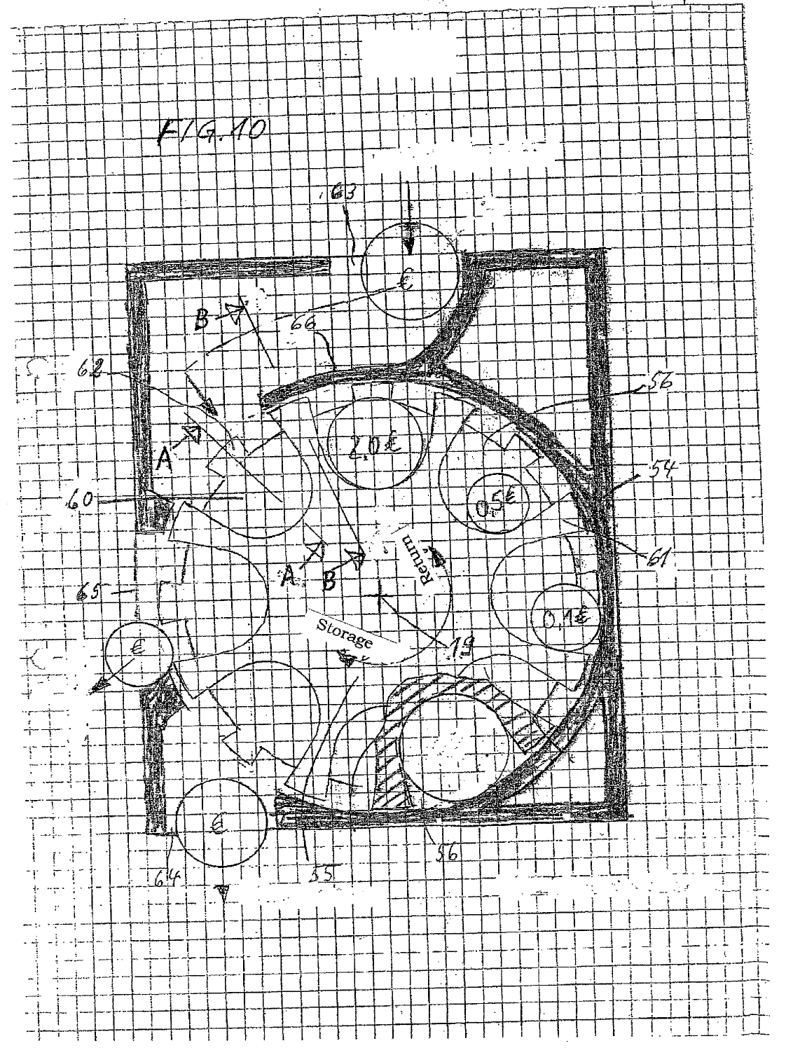

FIG. 9 a sectional view through a device with concentric vane wheels for the intermediate storage of coins of different sizes in the case of a magazine with filling function,

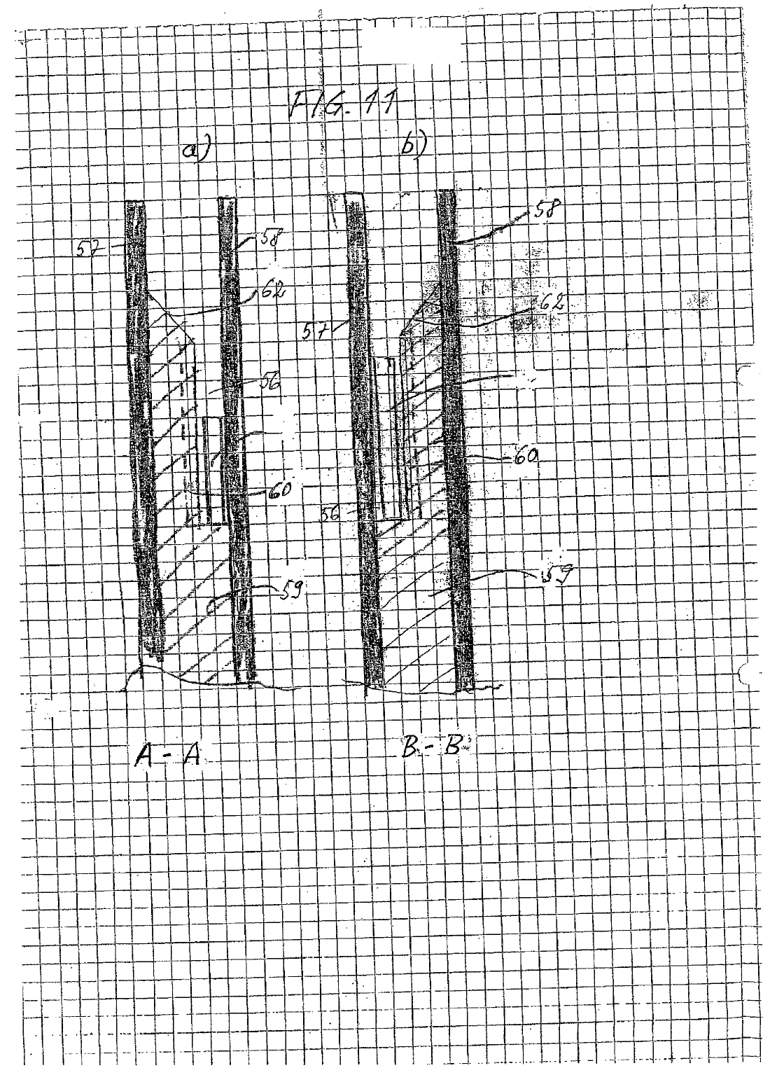

FIG. 10 a sectional view of the additional storage space formed as storage wheel, and

FIG. 11 two sectional views of the storage wheel according to FIG. 10.

The intermediate store is formed, in the case of the device according to FIG. 1, from a plurality of magazine bodies 1 which are situated one behind the other perpendicular to the drawing plane. Each magazine body 1 serves for receiving coins of the same value, the coins to be received in the various magazine bodies 1 normally having a different size.

Above the intermediate store there is a coin tester 2 from which coins recognised as valid fall onto a ramp angle 3 and roll on the latter into a conveying carriage 4. The conveying carriage 4 is moved with a coin by a drive 5 along a guide shaft 6 perpendicular to the drawing plane so that the respective coins can be conveyed up to the magazine body provided for them. The coins thereby roll, in the initial position of the conveying carriage 4, firstly towards a catch lever 7 which is situated pivotably between two positions and normally situated pivoted in the clockwise direction and then, when they are moved out of the region of the catch lever 7, abut, on the one hand, against an angle bracket 8 and, on the other hand, are retained by the ramp angle 3 from falling down through a gap 9 formed between these.

The conveying carriage 4 represented in FIG. 5 in plan view in its initial position contains two parallel walls 10, between which the inserted coin is held loosely and which form a funnel-like widening on the inlet side of the coin.

The ramp angle 3, as the plan view according to FIG. 3 shows, is widened from the initial position (0 position) of the conveying carriage 4 in stages, the widening corresponding to the size differences of the coins to be stored. Thus, when the conveying carriage 4 moves across the gap 9, the respective coins fall through the gap 9 at the position at which the width of the gap 9 exceeds the diameter of the coin. FIG. 3 shows a coin 11 with the smallest diameter and a coin 12 with a large diameter. In its position shown in FIG. 1, the catch lever 7 prevents even the smallest coin 11 being able to fall through the gap 9 in the initial position of the conveying carriage 4.

The ramp angle 3 is configured such that the gap 9 is narrowest in the centre of the travel path of the conveying carriage 4. From this centre, the gap widens irregularly at both sides such that the widenings on the one side are intended for passage of the second smallest, fourth smallest, . . . and on the other side, for the passage of the third smallest, fifth smallest, . . . coin. The drive 5 receives the command from the coin tester 2 in which direction the conveying carriage 4 should be moved. By arrangement of the initial position of the conveying carriage 4 in the centre of the travel path, the travel routes of the conveying carriage 4 are shortened relative to the arrangement at one end of the travel path so that the coin insertion process can be implemented correspondingly faster.

The ramp angle 3, the conveying carriage 4, the drive 5, the guide shaft 6, the catch lever 7 and the angle bracket 8 form a sorting device 13.

Underneath the gap 9, each magazine body 1 has a coin inlet shaft 14 through which the coin falls, sorted according to size. Each magazine body 1 contains a vane wheel with a cylindrical inner ring 15 on which, at equal spacings in the circumferential direction, entrainer webs 16 which protrude radially outwards are disposed. The spacing between two adjacent entrainer webs 16 is dimensioned such that a coin of the size assigned to the relevant vane wheel can be received between them. The height of the entrainer webs 16 corresponds approximately to half the diameter of a received coin. The inner ring 15 with the entrainer webs 16 is rotatable about an axis 19 by means of a motor 17 and via a transmission 18. Coins located between the entrainer webs 16 are thereby entrained.

Each magazine body 1 contains in addition a stationary outer ring 20 which has a helical groove on its inside. A helical coin-conducting web 21 is inserted in this groove and extends hence in the circumferential direction over a plurality of complete rotations of the vane wheel. The inclination of the helix formed by the coin-conducting web 21 is such that, upon a rotation, a spacing is obtained in the direction of the axis 19 which corresponds to the thickness of a coin and a small clearance so that a received coin can be guided by the rear entrainer web 16 in the direction of rotation without jamming over a plurality of rotations, along the helical coin-conducting track formed by the coin-conducting web 21.

After a coin has fallen through the coin inlet shaft 14 of a magazine body 1 and the outer ring 20 between two entrainer webs 16 of a vane wheel, the inner ring 15 is rotated by a distance which corresponds to the spacing between two adjacent entrainer webs 16 in the filling direction, i.e. in the anticlockwise direction in FIG. 1. Under the coin inlet shaft 14 there is then again a free compartment for receiving the next coin. Via a position sensor 22, the respective position of rotation of the vane wheel can be adjusted precisely. The magazine can be filled in this way. If the vane wheel has performed a plurality of rotations corresponding to the number of the turn of the coin-conducting web 21, the vane wheel is filled. In each intermediate space between two adjacent entrainer webs 16 there are a plurality of coins, one behind the other, in the direction of the axis 19, as is shown in FIG. 2 for large coins 12. When the vane wheel is filled, with each further gradual movement of the vane wheel in the filling direction in which space is produced for receiving a new coin, the first stored of the coins located in the vane wheel falls through a final cash store shaft 23 into a final cash store (collection container) 24.

If change is been given back or if a payment process is interrupted with the result that the coins already inserted during this payment process must be returned, the vane wheel is rotated in the return direction, i.e. counter to the filling direction, as a result of which the just inserted coin(s) falls (fall) into a return shaft 25. The vane wheel hereby performs as many steps as are required to dispense coins.

Since the individual vane wheels store coins of equal size but the different vane wheels store coins of different sizes, the interior of the magazine bodies 1 must be configured correspondingly, i.e. the spacing between the entrainer webs 16 and the spacing between the inner ring 15 and the outer ring must be adapted to the coin diameter. In order to keep the manufacturing costs as low as possible, only as few parts as possible should however have a different configuration. In the present case, this is merely the inner ring 15 with the webs 16 disposed thereon. FIG. 1 shows the corresponding configuration for a small coin 11, an average coin 26 and a large coin 12, these requiring to be assigned to various magazine bodies 1. As is evident, in fact the spacing between the entrainer webs 16 is adjusted corresponding to the coin diameter but the spacing between the inner ring 15 and the outer ring 20 remains the same for all coin sizes. In the case of vane wheels for small coins 11 and average coins 26, a support web 27 which protrudes radially outwards from the inner ring 15 is provided between respectively two entrainer webs 16 and on which support web the received coin rests. The height of the respective support web 27 changes inversely to the diameter of the coins to be received so that the spacing thereof from the outer ring 20 remains the same for all coin sizes. By adapting the mutual spacing of the entrainer webs 16 to the coin diameter, a vane wheel for small coins can receive more coins than a vane wheel for large coins. Correspondingly, also the individual rotational steps in the case of a vane wheel for small coins are shorter than in the case of a vane wheel for large coins.

In undisrupted operation, the processes of insertion, intermediate storage, returning and collecting of coins takes place in the previously described manner. If a disruption, for example by jamming of a coin, takes place, the known devices were switched off in total so that neither coin acceptance nor corresponding return service, for example issuing an object purchased by the coin insertion, were able to be implemented.

This defect is remedied by the present invention. If a disturbance is established in the intermediate store, then the catch lever 7 which is pivoted, during correct operation, over the gap 9 (FIG. 4c) such that it prevents even the smallest coins 11 falling through is pivoted back (dashed representation in FIG. 4c) such that now even the largest coins 12 can roll down from the ramp angle 3 and can fall into the gap 9 through the conveying carriage 4 located in the initial position. The angle bracket 8 is recessed in the region of the catch lever 7 such that it likewise does not impede passage of the coins 12 either.

Below the gap 9 in the region of the catch lever 7 there is an intermediate cash module 28 which has the same outer configuration as a magazine body 1. FIG. 6 shows the interior of the intermediate cash module 28, from a viewing direction which is opposite to the viewing direction in FIG. 1.

The intermediate cash module 28 contains a coin inlet shaft 29 which discharges into an opening below the gap 9. When the catch lever 7 is pivoted back, i.e. in the case of an operational disruption, all the coins recognised by the coin tester 2 as valid fall from the ramp angle 3 through the conveying carriage which is in the initial position directly into the coin inlet shaft 29 and onto a sorting rocker 30 of a coin storage space 31. Hence no sorting of the inserted coins corresponding to their value takes place. The sorting rocker 30 is pivotable about an axis 32 located in the centre thereof and is located, during coin insertion, in the central position thereof in which it closes the coin storage space 31 on the base side.

The sorting rocker 30 is pivotable by a servomotor 33 via a connecting rod spring 34 either in the clockwise direction or anticlockwise direction. The sorting rocker 30 is pivoted respectively in the clockwise direction according to FIG. 6 after completion of a concluded payment process so that the coin storage space 31 on the right hand side of the sorting rocker 30 is opened and the coins inserted during the previous payment process fall unsorted into a final cash store shaft 35 and from the latter into the final cash store 24 situated thereunder.

If a payment process is to be cancelled before it is concluded, then the servomotor 33 is actuated such that it pivots the sorting rocker 30 in the anticlockwise direction according to FIG. 6. The coin storage space 31 is hence opened on the left hand side of the sorting rocker 30 and the coins inserted during the interrupted payment process slide from the sorting rocker 30 into a return shaft 36, from which they pass into a return dish and can be removed therefrom.

Before the beginning of the next payment process, the sorting rocker 30 is guided back into its central position.

It is ensured in this way that, even when there is an operational disruption to the intermediate store, the automatic machine can continue to perform, with the restriction that return of change is not possible. The user is made aware of this by a corresponding display.

FIG. 7 shows a particular configuration of the magazine, in which a magazine body 37 contains two vane wheels for receiving coins of different sizes which are disposed one above the other. This magazine body 37 has an upper coin inlet shaft 38 for the upper vane wheel and a lower coin inlet shaft 39 for the lower vane wheel which is separate herefrom. In contrast, a common return shaft which is connected to an upper outlet opening 41 for the upper vane wheel and to a lower outlet opening 42 for the lower vane wheel and also a common final cash store shaft 43 which is connected to an upper overflow opening of the upper vane wheel and to a lower overflow opening of the lower vane wheel are provided.

The functions of insertion, intermediate storage, returning and collecting of coins are the same as in the case of the magazine according to FIG. 1.

In the case of the magazine shown in FIG. 7, an intermediate cash module 44, as shown in FIG. 8, can be used. The coin storage space 45 comprises here semicircular segments which are disposed one above the other. After passing the pivoted-back catch lever 7, the coins are inserted into the coin storage space 45 unsorted through the conveying carriage 4 located in the initial position. The depth of the coin storage space 45, i.e. the dimension perpendicular to the drawing plane in FIG. 8, is chosen such that the coins can lie in this direction not one behind the other but only one above the other. Furthermore, projections which extend through the semicircular limits of the coin storage space 45 respectively up to approximately the longitudinal axis thereof are formed, on which projections the coins can be supported. Hence a free fall of the coins is prevented on the one hand and, on the other hand, only the weight of the lowermost coin rests on a sorting lever 46 so that the latter can be pivoted without difficulty about an axis 47. The coin passage in the coin storage space 45 is however not so narrowed at any point that the danger of jamming should be feared.

The sorting lever 46 has the same function as the sorting rocker 30. In its extended illustrated position A, it prevents emergence of coins from the coin storage space 45. The sorting lever 46 can be pivoted into position B in the anticlockwise direction or into position C in the clockwise direction. Pivoting into position B is effected after conclusion of a payment process so that the coins inserted into the coin storage space 45 during the payment process are conducted into a final cash store shaft 48. If in contrast a payment process is interrupted before its completion, the sorting lever 46 is pivoted into position C and the coins are guided into a return shaft 49.

In the case of the device shown in FIG. 9, the magazine body 50 contains a plurality of concentric vane wheels for intermediate storage of coins 11, 26 and 12 of different sizes, the outer vane wheel storing large coins 12, the central vane wheel average coins 26 and the inner vane wheel small coins 11. Coins which are judged by the coin tester 2 to be valid pass via the ramp angle 3 and, after conveying by the conveying carriage 4 from the region of the catch lever 7, through the gap 9 into the coin inlet shaft 14. Coins judged to be invalid by the coin tester 2 are conducted directly into a return shaft 51.

The inner ring 15 of the outer vane wheel contains slot-like passages 52 between the entrainer webs 16 which are dimensioned such that they allow small and average coins 11 and 26 to pass through but prevent passage of large coins 12. In a corresponding manner, the inner ring 15 of the central vane wheel contains slot-like passages 53 between the entrainer webs 16 which are dimensioned such that they allow small coins 11 to pass through but prevent passage of average coins 26. In this way the large coins 12 pass into the outer vane wheel, in the manner described with reference to FIG. 1, the average coins 26 into the central vane wheel and the small coins 11 into the inner vane wheel in order to be stored respectively intermediately in the latter.

In the case of an operational disruption of the intermediate store, the catch lever 7 is pivoted back in the anticlockwise direction so that coins of all sizes pass into the coin storage space 45 of the intermediate cash module 44 in the initial position of the conveying carriage 4. Said intermediate cash module is constructed similarly and has the same function as the intermediate cash module 44 in FIG. 8.

A device provided for example for coins with six different values comprises preferably two magazine bodies 50 between which the intermediate cash module 44 is disposed. A corresponding arrangement is also expedient when using the magazine bodies 37 according to FIG. 7 in which however only coins of four different values can be stored intermediately.

FIG. 10 shows an intermediate cash module 54 which is disposed directly below the catch lever 7 between the magazine bodies 1 for receiving coins with respectively a specific value. The intermediate cash module 54 has the same outer dimensions as the magazine bodies 1 so that the device can have a very compact configuration.

The intermediate cash module 54 contains a storage wheel 55 which is rotatable about the axis 19 and is provided with pockets 56, which serve to receive coins, along the outer circumference. The pockets 56 are so large that they can receive the largest coin to be stored. The storage wheel 55 can likewise be rotated in steps like the vane wheels.

As the sectional representations in FIG. 11 show, the storage wheel 55 comprises two parallel plates 57 and 58 between which an essentially circular disc 59 which forms the pockets 56 is received. In the centre between the plates 57 and 58, the disc 59 forms a circular separating wall 60. The pockets 56, as shown in FIGS. 11a and 11b, are disposed on both sides of the separating wall 60. The pockets 56 situated on one side of the separating wall 60 are disposed, separated from each other by intermediate walls 61, at equal spacings along the circumference of the storage wheel 55. The pockets 56 configured on the other side of the separating wall 60 are disposed similarly but offset by half a pocket spacing relative to the pockets 56 on the oppositely situated side. The pocket 56 shown in FIG. 10 bottom right is located behind the separating wall 60 and its assignment to the pockets 56 disposed in FIG. 10 in front of the separating wall 60 can be detected. The pockets 56 on both sides of the separating wall 60 hence overlap with each other in the circumferential direction but are not connected to each other. In the radial direction outwith each pocket 56, the disc 59 forms a sliding diagonal 62 in order to conduct supplied coins reliably into the respective pocket 56.

The intermediate cash module 54 contains three openings, namely one opening 63 leading to the coin inlet shaft 14, one opening 64 leading to the final cash store and one opening 65 leading to the return shaft. A conducting web 66 guides coins inserted through the opening 63 to a pocket 56 located in a specific angle position of the storage wheel 55.

If the catch lever 7 is pivoted back because of a disruption, all the coins accepted by the coin tester 2 fall through the opening 63 into the intermediate cash module 54 and pass via the conducting web 66 into the pocket 56 which is located at a specific position of rotation of the storage wheel 55. After such a coin is received in the storage wheel 55, the latter is rotated by one step in the clockwise direction, in FIG. 10, which corresponds to half the spacing between two adjacent pockets 56 on the same side of the separating wall 60 (half step). Hence the storage wheel 55 is free for receiving the next coin in the overlapping pocket 56 on the other side of the separating wall 60. In that the storage wheel 55 is rotated in the clockwise direction after each insertion of a coin by half a step, the pockets 56 on each side of the separating wall 60 are filled continuously with respectively one coin until the respective pocket 56 reaches a position in which it is situated opposite the opening 64 so that the corresponding coin can fall into the final cash store. The pocket 56 is then brought again into the insertion position during further rotation of the storage wheel 55, it being ensured that the pocket 56 has been emptied in advance.

If a payment process is interrupted and the coins already inserted during this payment process are to be returned again, then the storage wheel 55 is rotated in the anticlockwise direction, the first step being effected over an entire spacing between two adjacent pockets on the same side of the separating wall 60 (full step) in order that the last inserted coin is situated opposite the opening 65 and can fall through the latter into the return shaft. Thereafter, as many half steps are also performed in the anticlockwise direction as the number of coins which must be returned in addition to the last coin. After conclusion of the return process, a full step is again effected in the clockwise direction in order that an empty pocket 56 is again located in the insertion position.

The intermediate cash module 54 enables the configuration of a compact device, has a large storage capacity by providing pockets 56 on both sides of the separating wall 60 and requires no rocker or lever in order to convey the coins either to the final cash store or to the return shaft. Therefore the susceptibility to problems is low.

1-22. (canceled)

23. A device for an intermediate storage, a collection and a dispensing of coins, comprising:
at least one magazine controllably receiving, intermediately storing and controllably returning the coins;
an overflow dispensing the coins in a collection container when the at least one magazine is filled; and
an additional storage space controllably receiving the coins inserted during an insertion process upon the at least one magazine being operationally disrupted, the additional storage space controllably dispensing the received coins of the insertion process to one of a return device and the collection container.

24. The device according to claim 23, further comprising:
a lever pivoting to at least two positions for conducting the coins into one of the at least one magazine and the storage space.

25. The device according to claim 24, wherein the positions are based on one of a disruption-free operation and a disrupted operation of the at least one magazine.

26. The device according to claim 24, wherein the lever is a catch element which, in a first position, prevents direct access of the coins to the storage space and, in a second position, creates a direct access of the coins to the storage space.

27. The device according to claim 26, further comprising:
a coin-conveying device conveying the coins retained by the catch element to at least one coin inlet opening of the at least one magazine.

28. The device according to claim 27, wherein the coin conveyance device is effected to a plurality of coin inlet openings of different sizes.

29. The device according to claim 23, wherein the storage space includes a controllable dispensing device dispensing the coins received during the insertion process to one of a return device and the collection container.

30. The device according to claim 29, wherein the dispensing device contains a controllable element with a first predefined position for receiving the coins, a second predefined position for dispensing the coins to the return device, and a third predefined position for dispensing the coins into the collection container.

31. The device according to claim 30, wherein the storage space has inner projections which limit a falling movement and support the received coins.

32. The device according to claim 23, wherein the at least one magazine has at least one vane wheel conveying the coins received in the at least one magazine along a circular track.

33. The device according to claim 32, wherein the vane wheel is surrounded by a concentric helical coin-conducting web.

34. The device according to claim 32, wherein the vane wheel has an inner ring and entrainer webs protruding radially outwards from the inner ring and extend in a direction of an axis of rotation of the vane wheel, the entrainer webs having a reciprocal spacing in the circumferential direction for receiving one of the coins.

35. The device according to claim 32, further comprising:
a support web situated between two adjacent entrainer webs, the support web extending substantially parallel to the two adjacent entrainer webs and protrudes radially from the inner ring to adjust a height of the one of the coins received by the vane wheel.

36. The device according to claim 32, wherein the at least one magazine has a plurality of vane wheels receiving coins of different sizes, each vane wheel receiving coins of a same size.

37. The device according to claim 36, wherein the at least one magazine has a plurality of vane wheels which are disposed adjacently in a direction of an axis of rotation.

38. The device according to claim 36, wherein the at least one magazine has a plurality of vane wheels which are disposed one above another, each vane wheel having a respective coin inlet shaft.

39. The device according to claim 36, wherein the at least one magazine has a plurality of vane wheels which are disposed concentrically within each other so that an outermost vane wheel receives a largest size coin and an innermost vane wheel receives a smallest size coin, the vane wheels containing passages for a passage of the coins to be received by the respectively inner vane wheel.

40. The device according to claim 39, wherein the additional storage space is situated between two vane wheels which are disposed adjacently in a direction of an axis of rotation.

41. The device according to claim 23, wherein the additional storage space is formed by a storage wheel with pockets for receiving coins.

42. The device according to claim 41, wherein the storage wheel is rotatable in a first direction for storing the coins and dispensing the coins into the collection container and in a second direction for returning the coins, the first direction being opposite to the second direction.

43. The device according to claim 41, wherein the pockets overlap each other in a circumferential direction, the pockets being mutually offset in an axial direction, the pockets being separated by a wall.

44. The device according to claim 41, further comprising:
a stationary ring situated opposite a circumferential surface of the storage wheel, the stationary ring having openings for insertion, dispensing into the collection container, and returning the coins.
